(19) United States
(12) Patent Application Publication
(10) Pub. No.: US 2026/0358740 A1
(43) Pub. Date: Nov. 12, 2026

(54) IMAGE FORMING APPARATUS AND FLUIDITY DETERMINATION METHOD

(71) Applicant: Konica Minolta, Inc., Tokyo (JP)

(72) Inventors: Tomo KITADA, Kanagawa (JP); Ryoei IKARI, Saitama (JP); Takashi YAMADA, Tokyo (JP); Masahiro ONODERA, Tokyo (JP); Motoki HIRONAKA, Tokyo (JP)

(21) Appl. No.: 19/660,362

(22) Filed: Apr. 28, 2026

(30) Foreign Application Priority Data
May 8, 2025 (JP) 2025-077924

(51) Int. Cl. G03G 15/00; G03G 15/08

(52) U.S. Cl. CPC G03G 15/553; G03G 15/0889; G03G 15/50

(57) ABSTRACT

Provided is an image forming apparatus that includes: a developing apparatus that accommodates a developer; an agitating member that agitates the developer by a rotational operation; a torque waveform acquirer that acquires a torque waveform indicating a driving torque of the agitating member; and a fluidity determiner that analyzes the torque waveform acquired by the torque waveform acquirer and determines, based on a shape of the torque waveform, whether fluidity of the developer is suitable.

### CROSS REFERENCE TO RELATED APPLICATIONS

The entire disclosure of Japanese Patent Application No. 2025-077924, filed on May 8, 2025, is incorporated herein by reference in its entirety.

### BACKGROUND

### Technological Field

The present disclosure relates to an image forming apparatus and a fluidity determination method.

### Description of Related Art

In an image forming apparatus (a printer, a copier, a facsimile, or the like) utilizing an electrophotographic process technology, laser light based on image data is emitted to a uniformly charged photoreceptor (a uniformly charged photoconductor is exposed to laser light based on image data) so that an electrostatic latent image is formed on the surface of the photoreceptor. Then, toner is supplied to the photoreceptor and the electrostatic latent image is visualized as a toner image. The toner image is transferred onto a recording material, and is then heated and pressurized at a fixing section. Through the above steps, an image is formed on the recording material.

In general, developers accommodated in a developing apparatus are rubbed against each other during the conveyance process by a conveyance screw and become triboelectrically charged. For this reason, the developer deteriorates over time. Since a deteriorated developer causes an image defect, the deteriorated developer is discharged from the developing apparatus as appropriate, and a new developer is supplied. The degree of deterioration of the developer can be determined using, for example, the fluidity of the developer as an index (see, for example, Patent Literature (hereinafter referred to as “PTL”) 1 (Japanese Patent Application Laid-Open No. 2004-170660)).

PTL 1 discloses detecting the rotation torque of an agitating screw as a physical quantity indicating the fluidity of a developer, and determining the degree of deterioration of the developer based on the detected rotation torque. The rotation torque of the agitating screw can be directly detected by, for example, a torque measuring device attached to the agitating screw shaft (see PTL 1 (Japanese Patent Application Laid-Open No. 2004-170660)). In addition, for example, the rotation torque of an agitating screw can be detected based on a driving current waveform of a motor that drives the agitating screw (see PTL 2 (Japanese Patent Application Laid-Open No. 2008-250152) and PTL 3 (Japanese Patent Application Laid-Open No. 2011-197258)).

However, in PTL 1, the rotation torque of the agitating screw fluctuates depending on the amount of the developer accommodated in the developing apparatus, the toner concentration, and environmental factors (temperature and humidity), and thus, the fluidity of the developer cannot be determined based only on the detected value of the rotation torque. The toner concentration represents the ratio of toner in the developer.

### SUMMARY

An object of the present disclosure is to provide an image forming apparatus and a fluidity determination method each of which is capable of easily and appropriately determining the fluidity of a developer accommodated in a developing apparatus.

In order to achieve at least one of the above-described objects, an image forming apparatus according to one aspect of the present invention comprises:
a developing apparatus that accommodates a developer;
an agitating member that agitates the developer by a rotational operation;
a torque waveform acquirer that acquires a torque waveform indicating a driving torque of the agitating member; and
a fluidity determiner that analyzes the torque waveform acquired by the torque waveform acquirer and determines, based on a shape of the torque waveform, whether fluidity of the developer is suitable.

A fluidity determination method reflecting one aspect of the present invention comprises:
agitating a developer accommodated in a developing apparatus by a rotational operation of an agitating member;
acquiring a torque waveform indicating a driving torque of the agitating member;
analyzing the acquired torque waveform; and
determining, based on a shape of the torque waveform, whether fluidity of the developer is suitable.

### BRIEF DESCRIPTION OF DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a diagram schematically illustrating the overall configuration of an image forming apparatus;

FIG. 2 is a diagram illustrating a main part of a control system of the image forming apparatus;

FIG. 3 is a diagram illustrating the configuration of an image forming section;

FIG. 4 is a schematic diagram illustrating the configuration of a developing apparatus;

FIGS. 5A to 5C are diagrams illustrating the behavior of a developer when a first agitating screw is rotated;

FIG. 6 is a diagram illustrating an example of a torque waveform when the first agitating screw is rotated;

FIGS. 7A and 7B are enlarged views of the one-cycle torque waveform in FIG. 6;

FIG. 8 is a flowchart illustrating an example of fluidity determination processing;

FIGS. 9A and 9B are diagrams illustrating examples of a fluidity determination method;

FIGS. 10A and 10B are diagrams illustrating other examples of the fluidity determination method; and

FIGS. 11A and 11B are diagrams illustrating other examples of the fluidity determination method.

### DETAILED DESCRIPTION OF EMBODIMENTS

Hereinafter, one or more embodiments of the present invention will be described with reference to the drawings. However, the scope of the invention is not limited to the disclosed embodiments.

Hereinafter, an embodiment of the present disclosure will be described in detail with reference to the accompanying drawings.

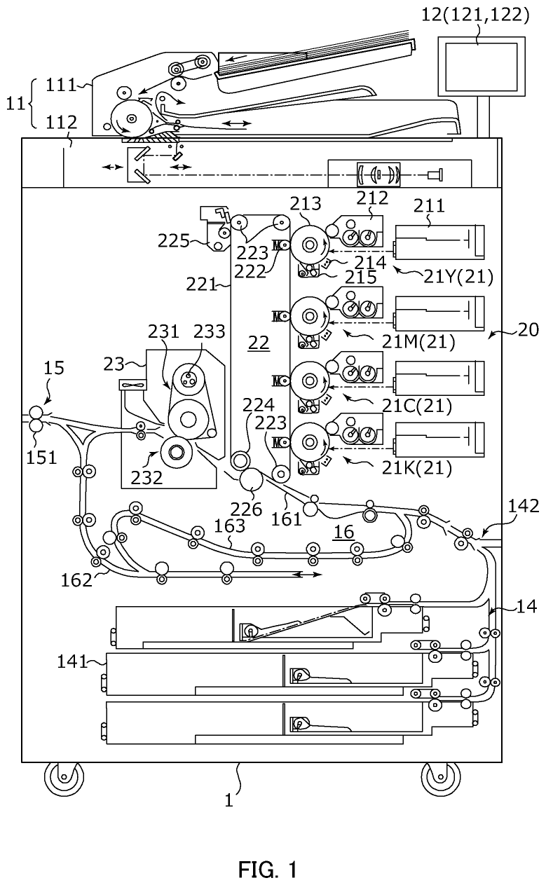

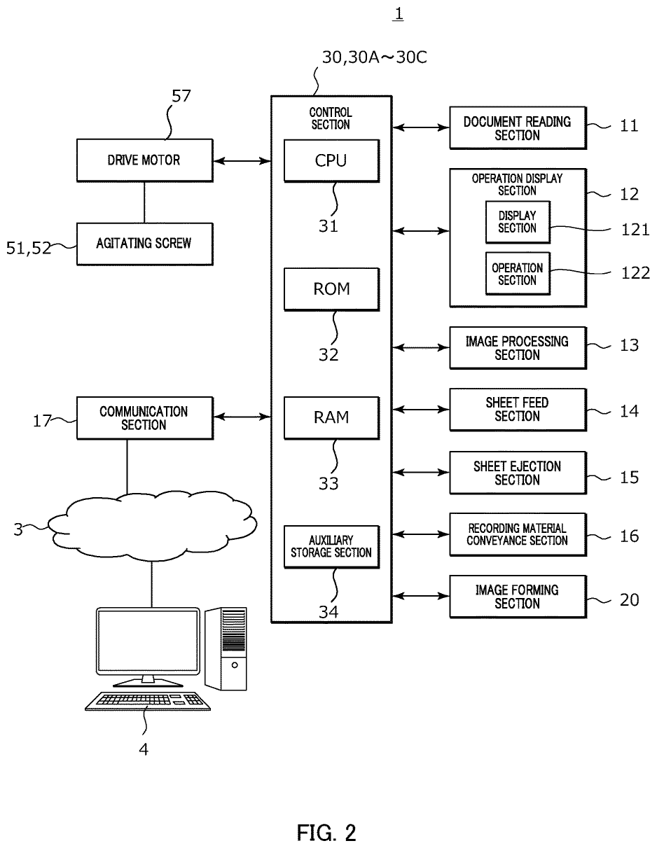

FIG. 1 is a diagram schematically illustrating the overall configuration of an image forming apparatus 1 according to an embodiment. FIG. 2 is a diagram illustrating a main part of a control system of the image forming apparatus 1.

The image forming apparatus 1 is a color image forming apparatus of an intermediate transfer method utilizing an electrophotographic process technology. The image forming apparatus 1 primary transfers toner images of respective colors of yellow (Y), magenta (M), cyan (C), and black (K) formed on photosensitive drums 213 onto an intermediate transfer belt 221. In addition, the image forming apparatus 1 superposes the toner images in the four colors on the intermediate transfer belt 221, and then secondarily transfers the toner images onto a recording material, thereby forming an image. Examples of the recording material include a sheet and a resin film.

In the present embodiment, a vertical tandem system is adopted for the image forming apparatus 1. In the vertical tandem system, the photosensitive drums 213 corresponding to the four colors of CMYK are arranged in series along the vertical direction of the intermediate transfer belt 221, and toner images of the respective colors are sequentially transferred onto the intermediate transfer belt 221 in one sequence.

The image forming apparatus 1 includes a document reading section 11, an operation display section 12, an image processing section 13, a sheet feed section 14, a sheet ejection section 15, a recording material conveyance section 16, a communication section 17, an image forming section 20, and a control section 30. The image forming section 20 includes an image creating section 21, an intermediate transfer section 22, and a fixing section 23.

The control section 30 performs overall control of the image forming apparatus 1 by controlling the document reading section 11, the operation display section 12, the image processing section 13, the sheet feed section 14, the sheet ejection section 15, the recording material conveyance section 16, the communication section 17, and the image forming section 20 according to the respective functions thereof.

The control section 30 includes a central processing unit (CPU) 31 as an arithmetic/control apparatus (processor), a read only memory (ROM) 32 as a main storage apparatus, a random access memory (RAM) 33, and the like. The control section 30 may include an auxiliary storage section 34. The auxiliary storage section 34 is constituted by, for example, a non-volatile semiconductor memory (so-called flash memory) such as a hard disk drive (HDD), a solid state drive (SSD), or a secure digital (SD) card.

The ROM 32 stores a basic program and basic setting data. In addition, the ROM 32 stores a program, a look-up table, and the like, which are read out when the operation of each block is controlled. The CPU 31 reads a program corresponding to the processing content from the ROM 32, loads the program into the RAM 33, and executes the loaded program, thereby controlling the operation of each functional block of the image forming apparatus 1.

In the present embodiment, the function of each functional block is implemented by cooperated operation between each hardware constituting the functional block and the control section 30. Note that, some or all of the functions of the functional blocks may also be implemented by the control section 30 executing a program. In addition, part of processing or the entire processing to be executed by the control section 30 may be executed by an electronic circuit provided according to the processing. Examples of the electronic circuit includes a digital signal processor (DSP), an application specific integrated circuit (ASIC), and a programmable logic device (PLD).

The control section 30 transmits and receives various kinds of data to and from an external apparatus 4 (for example, a computer) connected to a communication network 3 such as a local area network (LAN) or a wide area network (WAN) via the communication section 17. The communication section 17 is, for example, a communication interface such as a network interface card (NIC), a modulator-demodulator (MODEM), or a universal serial bus (USB). The communication section 17 may include a communication interface for short-range wireless communication such as near field communication (NFC) or Bluetooth (registered trademark). The external apparatus 4 is an information processing terminal operated by the user, and examples thereof include a personal computer, a tablet terminal, and a smartphone.

The control section 30 receives, for example, print job data transmitted from the external apparatus 4, and generates input image data based on the received print job data. The print job data is described in a predetermined page description language (PDL). Examples of the print job data includes data of image objects such as graphics and photographs, and data of text objects such as characters and symbols. The generated input image data is temporarily stored in an image memory (illustration is omitted).

When executing a print job, the control section 30 sets image formation conditions based on print setting information of the print job. The print setting information includes sheet setting information and print quality information. The image formation conditions are set by referring to, for example, a look-up table (LUT) stored in advance in the ROM 32.

In addition, the control section 30 performs fluidity determination processing. The fluidity determination processing is processing of determining the fluidity of a developer accommodated in a developing apparatus 212. The operation of the image forming apparatus 1 can be appropriately controlled using the determination result of the fluidity. In the fluidity determination processing, the control section 30 functions as a torque waveform acquirer 30A, a fluidity determiner 30B, and an operation controller 30C. Details of the fluidity determination processing will be described later.

The document reading section 11 includes an automatic document feed apparatus 111 called an auto document feeder (ADF), a document image scanning apparatus 112, and the like.

The automatic document feed apparatus 111 conveys a document, which has been placed on a document tray, by a conveyance mechanism and sends the document to the document image scanning apparatus 112. The automatic document feed apparatus 111 makes it possible to continuously read images (including both sides) of a large number of documents placed on the document tray.

The document image scanning apparatus 112 reads a document conveyed from the automatic document feed apparatus 111 onto a contact glass or a document placed on the contact glass. Specifically, the document image scanning apparatus 112 optically scans a document, forms an image of reflected light from the document on a light receiving surface of an imaging element (for example, a charge coupled device (CCD)), and reads a document image. The document reading section 11 generates input image data based on a reading result by the document image scanning apparatus 112. The generated input image data is temporarily stored in an image memory (illustration is omitted).

The operation display section 12 is constituted by, for example, a flat panel display with a touch screen. As the flat panel display, a liquid crystal display, an organic EL display, or the like can be used. The operation display section 12 includes a display section 121 and an operation section 122.

The display section 121 displays various operation screens, image states, operating statuses of functions, and the like according to a display control signal inputted from the control section 30.

The operation section 122 includes various operation keys such as a numeric keypad and a start key. The operation section 122 receives various input operations by the user, and outputs an operation signal to the control section 30. The user can operate the operation section 122 to perform settings related to image formation, such as document setting, image quality setting, magnification setting, application setting, output setting, and recording material setting.

The image processing section 13 includes a circuit or the like that performs digital image processing according to initial setting or user setting on the input image data. The image processing section 13 performs, for example, information extraction processing, image conversion processing, image combination processing, image filtering processing, and correction processing. The image forming section 20 is controlled on the basis of the image data subjected to the pieces of processing described above.

The image creating section 21 forms a toner image by each color toner of a Y component, an M component, a C component, and a K component based on the input image data. The intermediate transfer section 22 transfers the toner image formed by the image creating section 21 onto a recording material. The fixing section 23 fixes the transferred toner image to the recording material.

Specifically, the image creating section 21 is constituted by four image creating sections 21Y, 21M, 21C, and 21K for a Y component, an M component, a C component, and a K component. Since the image creating sections 21Y, 21M, 21C, and 21K have the same configuration, for convenience of illustration and description, common constituent elements are denoted by the same reference signs, and when common constituent elements are distinguished from each other, the common constituent elements are denoted by adding Y, M, C, and K to the reference signs thereof. Note that, in FIG. 1, only the constituent elements of the image creating section 21Y for the Y component are denoted by the reference signs, and the reference signs for the constituent elements of the other image creating sections 21M, 21C, 21K are omitted.

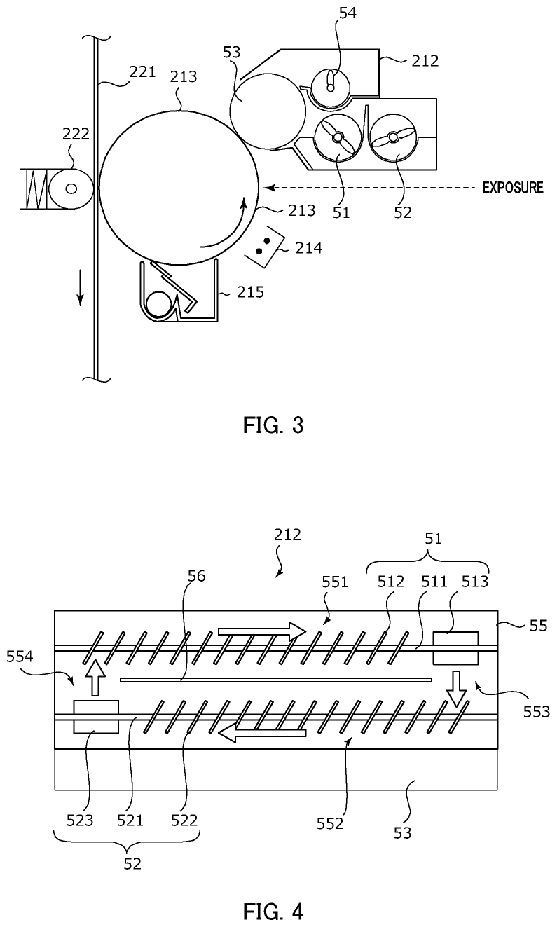

As illustrated in FIG. 3, the image creating section 21 includes an exposure apparatus 211, a developing apparatus 212, the photosensitive drum 213, a charging apparatus 214, a drum cleaning apparatus 215, and the like. Although illustration is omitted, the image creating section 21 may include a static elimination apparatus for removing residual charge remaining on the surface of the photosensitive drum 213 after the primary transfer.

The photosensitive drum 213 is, for example, a negative charge type organic photoconductor (OPC). The photosensitive drum 213 has a configuration in which, for example, an undercoat layer, a charge generation layer, and a charge transport layer are sequentially laminated on a periphery surface of a conductive cylindrical body made of aluminum (aluminum tube). The charge generation layer is composed of an organic semiconductor in which a charge generation material (for example, phthalocyanine pigment) is dispersed in a resin binder (for example, polycarbonate). The charge generation layer generates a pair of positive charge and negative charge upon exposure by the exposure apparatus 211. The charge transport layer has a configuration in which a hole transport material (electron-donating nitrogen-containing compound) is dispersed in a resin binder (for example, polycarbonate resin). The charge transport layer transports positive charge generated in the charge generation layer to the surface of the charge transport layer.

The charging apparatus 214 is constituted by, for example, a corona discharge generator such as a scorotron charging apparatus or a corotron charging apparatus. The control section 30 controls a charging bias application section (illustration is omitted) so that a charging bias is applied to the charging apparatus 214. The charging bias application section is, for example, a DC power supply circuit. The charging apparatus 214 generates corona discharge by the application of a charging bias and uniformly charges the surface of the photosensitive drum 213 to a negative polarity. The surface potential of the photosensitive drum 213 depends on the charging bias.

The exposure apparatus 211 includes, for example, an LED print head (LPH). The LPH includes an LED array, an LPH driving section (driver IC), a lens array, and the like. In the LED array, a plurality of light emitting diodes (LEDs) is linearly arranged. The LPH driving section drives each LED. The lens array forms an image of light emitted from the LED array on the photosensitive drum 213. One LED of the LED array corresponds to one dot of an image.

The exposure apparatus 211 emits light corresponding to an image of each color component to the photosensitive drum 213. The positive charge generated in the charge generation layer of the photosensitive drum 213 by receiving light emission is transported to the surface of the charge transport layer, and thus, the surface charge (negative charge) of the photosensitive drum 213 is neutralized. Thus, an electrostatic latent image of each color component is formed on the surface of the photosensitive drum 213 due to a potential difference from the surroundings.

The developing apparatus 212 accommodates a developer (for example, a two-component developer including toner and carrier) of each color component and attaches toner of each color component to the surface of the photosensitive drum 213 to visualize the electrostatic latent image and form a toner image. The control section 30 controls a developing bias application section (illustration is omitted) so that a developing bias is applied to a developing roller 53 (see FIG. 3). The developing bias application section is, for example, a DC power supply circuit. The developing bias application section may also include an AC power supply circuit in addition to the DC power supply circuit.

A developing bias is applied to the developing roller 53, and an electric field is formed between the photosensitive drum 213 and the developing roller 53. Due to a potential difference between the photosensitive drum 213 and the developing roller 53, the charging toner on the developing roller 53 flies to and adheres to an image portion (exposed portion) of the surface of the photosensitive drum 213. Thus, the electrostatic latent image on the photosensitive drum 213 is visualized. A detailed configuration of the developing apparatus 212 will be described later.

The drum cleaning apparatus 215 includes a cleaning blade (reference sign is omitted) that comes into sliding contact with the surface of the photosensitive drum 213, and the like. The drum cleaning apparatus 215 removes transfer residual toner remaining on the surface of the photosensitive drum 213 after the primary transfer.

The intermediate transfer section 22 includes the intermediate transfer belt 221, a primary transfer roller 222, a plurality of support rollers 223 and 224, a belt cleaning apparatus 225, a secondary transfer roller 226, and the like.

The intermediate transfer belt 221 is an image carrier that carries a toner image, and is a transfer-receiving body onto which the toner image on the photosensitive drum 213 is transferred. The intermediate transfer belt 221 is constituted by a belt having an endless shape and is stretched in a loop shape around the plurality of support rollers 223. At least one of the plurality of support rollers 223 is constituted by a drive roller, and the other support rollers 223 are constituted by driven rollers. As the drive roller rotates, the intermediate transfer belt 221 travels at a constant speed.

The primary transfer roller 222 is disposed on the inner periphery surface side of the intermediate transfer belt 221 so as to face the photosensitive drum 213 of each color component. When the primary transfer roller 222 is brought into pressure contact with the photosensitive drum 213 with the intermediate transfer belt 221 interposed therebetween, a primary transfer nip for transferring a toner image from the photosensitive drum 213 onto the intermediate transfer belt 221 is formed. The control section 30 controls a transfer bias application section (illustration is omitted) so that a primary transfer bias is applied to the primary transfer roller 222.

The support rollers 223 include an opposing roller 224 disposed to face the secondary transfer roller 226. The secondary transfer roller 226 is disposed on the outer periphery surface side of the intermediate transfer belt 221 and is brought into pressure contact with the opposing roller 224 with the intermediate transfer belt 221 interposed therebetween. Thus, a secondary transfer nip for transferring a toner image from the intermediate transfer belt 221 onto the recording material is formed. The control section 30 controls a transfer bias application section (illustration is omitted) so that a secondary transfer bias is applied to the secondary transfer roller 226.

At the primary transfer nip, the toner images on the photosensitive drums 213 are sequentially primary transferred in a superposed manner onto the intermediate transfer belt 221. Specifically, when a primary transfer bias is applied to the primary transfer roller 222, a charge having a polarity opposite to that of the toner is applied to an inner periphery surface side of the intermediate transfer belt 221 (the side on which the intermediate transfer belt 221 abuts on the primary transfer roller 222). The toner image is electrostatically transferred from the photosensitive drum 213 onto the intermediate transfer belt 221.

Thereafter, when the recording material passes through the secondary transfer nip, the toner image on the intermediate transfer belt 221 is secondarily transferred onto the recording material. Specifically, when a secondary transfer bias is applied to the secondary transfer roller 226, a charge having a polarity opposite to that of the toner is applied to the rear surface side of the recording material (the side on which the recording material abuts on the secondary transfer roller 226). The toner image is electrostatically transferred from the intermediate transfer belt 221 onto the recording material. The recording material onto which the toner image has been transferred is conveyed toward the fixing section 23.

he belt cleaning apparatus 225 includes a cleaning blade (reference sign is omitted) that comes into sliding contact with the surface of the intermediate transfer belt 221, and the like. The belt cleaning apparatus 225 removes transfer residual toner remaining on the surface of the intermediate transfer belt 221 after the secondary transfer.

The fixing section 23 includes an upper fixing section 231, a lower fixing section 232, a heating source 233, a pressure contact/separation section (illustration is omitted), and the like. The upper fixing section 231 includes a fixing surface side member disposed on the side of a fixing surface (the surface on which a toner image is formed) of the recording material. The lower fixing section 232 includes a rear surface side support member disposed on the side of a rear surface (the surface opposite to the fixing surface) of the recording material. The heating source 233 heats the fixing surface side member. The pressure contact/separation section brings the rear surface support member into pressure contact with the fixing surface side member.

The recording material onto which the toner image has been secondarily transferred and which has been conveyed along a sheet passage path is heated and pressurized when passing through the fixing section 23. Thus, the toner image is fixed to the recording material.

The sheet feed section 14 includes a sheet feed tray 141 and a manual sheet feed section 142. In the sheet feed tray 141, sheets (standard sheets and special sheets) identified based on the basis weight, size, and the like are accommodated for each sheet type set in advance. A plurality of sheet feed roller sections (reference sign is omitted) is disposed in the sheet feed tray 141 and the manual sheet feed section 142. An external sheet feed apparatus having a large capacity (illustration is omitted) can be connected to the manual sheet feed section 142. The external sheet feed apparatus may be capable of feeding a continuous sheet such as a roll sheet, for example. The sheet feed section 14 sends out a recording material, which has been fed from the sheet feed tray 141 or the manual sheet feed section 142, to the recording material conveyance section 16.

The sheet ejection section 15 includes a sheet ejection conveyance roller section 151. The sheet ejection section 15 ejects the recording material, which has been sent out from the recording material conveyance section 16, to the outside of the apparatus.

The recording material conveyance section 16 includes a main conveyance section 161, a switchback conveyance section 162, a rear surface printing conveyance section 163, a sheet passage path switching section (illustration is omitted), and the like. Part of the recording material conveyance section 16 may be incorporated, together with the fixing section 23, into one unit, for example, and may be detachably attached to the image forming apparatus 1.

The main conveyance section 161 includes a recording material conveyance element that sandwiches and conveys a recording material. Examples of the recording material conveyance element include a plurality of conveyance roller sections (reference sign is omitted) including a loop roller section and a registration roller section. The main conveyance section 161 conveys a recording material fed from the sheet feed section 14 and passes the recording material to the image forming section 20 (the intermediate transfer section 22 and the fixing section 23). In addition, the main conveyance section 161 conveys a recording material, which has been sent out from the image forming section 20 (the fixing section 23), toward the sheet ejection section 15 or the switchback conveyance section 162.

The switchback conveyance section 162 temporarily stops the recording material sent out from the fixing section 23, reverses the conveyance direction, and conveys the recording material to the sheet ejection section 15 or the rear surface printing conveyance section 163.

The rear surface printing conveyance section 163 circulates and conveys the recording material, which has been switched back by the switchback conveyance section 162, to the main conveyance section 161. The recording material is passed through the main conveyance section 161 in a state in which the rear surface is an image forming surface.

The sheet passage path switching section (illustration is omitted) is disposed on the downstream side of the fixing section 23 in the recording material conveyance direction. The sheet passage path switching section switches the sheet passage path depending on whether the recording material, which has been sent out from the fixing section 23, is ejected as it is, is flipped and dejected, or is conveyed to the rear surface printing conveyance section 163. Specifically, the control section 30 controls the operation of the sheet passage path switching section (illustration is omitted) on the basis of the processing content (single-sided/double-sided printing, face-up/face-down ejection, and the like) of the image formation processing.

The recording material fed from the sheet feed section 14 is conveyed to the image forming section 20 by the main conveyance section 161. Then, when the recording material passes through the secondary transfer section, the toner images on the intermediate transfer belt 221 are collectively transferred onto a first surface (front surface) of the recording material, and fixing processing is performed at the fixing section 23. The recording material on which an image has been formed is ejected to the outside of the apparatus by the sheet ejection section 15. In a case where images are formed on both surfaces of a recording material, the recording material, on the first surface of which an image has been formed, is sent out to the switchback conveyance section 162. Then, the recording material is flipped by returning to the main conveyance section 161 through the rear surface printing conveyance section 163, and an image is formed on a second surface (the rear surface).

FIG. 3 is a diagram illustrating the configuration of the image forming section 20 (excluding the fixing section 23). FIG. 4 is a plan view of the developing apparatus 212, which schematically illustrates the configuration thereof.

As illustrated in FIGS. 3 and 4, the developing apparatus 212 includes a first agitating screw 51, a second agitating screw 52, the developing roller 53, a collection roller 54, a developer container 55, and the like. The first agitating screw 51 and the second agitating screw 52 are examples of the agitating member that agitates the developer by a rotational operation.

The developer container 55 is partitioned by a partition wall 56 into a agitating chamber 551 for agitating the developer and a developing chamber 552 for supplying the developer to the developing roller 53. Circulation ports 553 and 554 are provided on the both sides of the partition wall 56 in the longitudinal direction. The developer container 55 includes bearing sections (illustration is omitted) that support the first agitating screw 51 and the second agitating screw 52, respectively.

The first agitating screw 51 and the second agitating screw 52 extend in the axial direction and are arranged side by side with the partition wall 56 interposed therebetween. The first agitating screw 51 is disposed in the agitating chamber 551, and the second agitating screw 52 is disposed in the developing chamber 552.

The first agitating screw 51 includes a screw shaft 511, a helical blade 512, and a paddle 513. The helical blade 512 is formed in a helical shape around the screw shaft 511. The helical blade 512 conveys the developer in the axial direction as the first agitating screw 51 rotates.

The paddle 513 is a plate-shaped blade member attached to the screw shaft 511 at an angle of approximately 90°. The paddle 513 is disposed on the side of the leading end of the first agitating screw 51 in the conveyance direction of the developer. As the first agitating screw 51 rotates, the paddle 513 changes the conveyance direction of the developer by 90° and sends out the developer toward the circulation port 553.

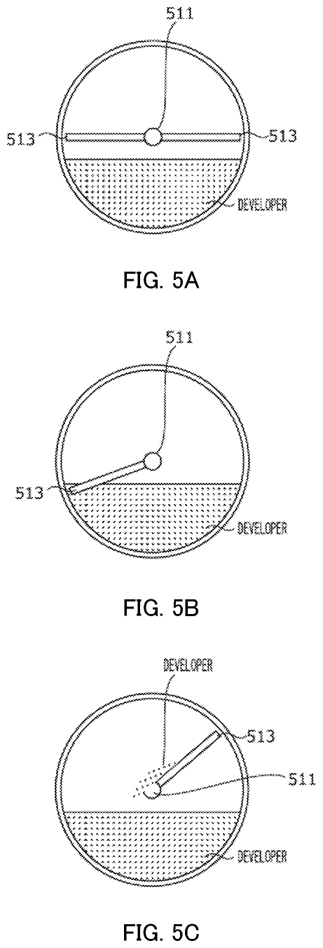

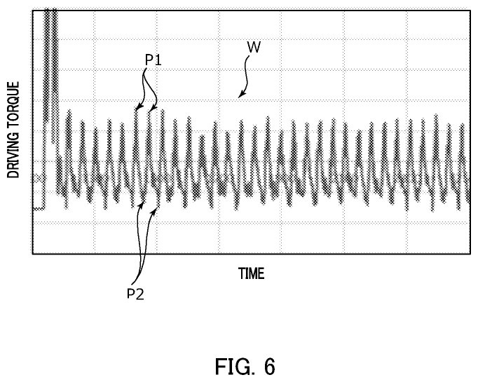

The paddle 513 functions as a load generator that cyclically moves between the inside of the developer and the outside of the developer in conjunction with the rotational operation of the first agitating screw 51 (see FIGS. 5A to 5C). By providing the paddle 513, a prominent peak can be caused to appear in a torque waveform of the first agitating screw 51.

The paddle 513 may be provided as a single paddle or as a plurality of paddles. In a case where a plurality of paddles 513 is provided, the paddles 513 are preferably disposed at positions that are rotationally symmetric with respect to each other. In the example illustrated in FIG. 5A, two paddles 513 are disposed at positions that are rotationally symmetric with respect to a 180° rotation. In FIGS. 5B and 5C, one of the paddles 513 is omitted to facilitate understanding of the behavior of the developer.

In the same manner as the first agitating screw 51, the second agitating screw 52 includes a screw shaft 521, a helical blade 522, and a paddle 523.

A drive motor 57 (see FIG. 2) is connected to the first agitating screw 51 and the second agitating screw 52 via, for example, a gear transmission mechanism. The control section 30 controls the drive motor 57 to cause the first agitating screw 51 and the second agitating screw 52 to rotate such that the developer is conveyed in opposite directions.

In FIG. 4, the first agitating screw 51 conveys the developer from the left side to the right side while agitating the developer. The developer is transferred from the agitating chamber 551 to the developing chamber 552 through the circulation port 553. The second agitating screw 52 conveys the developer from the right side to the left side while agitating the developer. The developer is circulated and conveyed through the circulation port 554. During the process in which the developer is circulated and conveyed by the first agitating screw 51 and the second agitating screw 52, a portion of the developer is supplied to the developing roller 53.

For example, the drive motors 57 are separately provided correspondingly to the first agitating screw 51 and the second agitating screw 52, and are capable of driving the first agitating screw 51 and the second agitating screw 52 independently. The rotational speeds of the first agitating screw 51 and the second agitating screw 52 are adjusted by controlling each number of rotations of the drive motors 57 that correspond to the first agitating screw 51 and the second agitating screw 52, respectively.

The control section 30 performs feedback control in which a current value is adjusted in real time such that the number of rotations of the drive motor 57 is stabilized. For this reason, the driving torques of the first agitating screw 51 and the second agitating screw 52 are correlated with the driving current. That is, the driving current of the drive motor 57 can be treated as a physical quantity indicating the driving torques of the first agitating screw 51 and the second agitating screw 52.

In a case where the fluidity of the developer accommodated in the developer container 55 is low, the resistance when the first agitating screw 51 and the second agitating screw 52 rotate tends to be greater than in a case where the fluidity of the developer is high. In addition, in a case where the degree of deterioration of the developer is large, the fluidity of the developer tends to be low. Accordingly, the fluidity of the developer can be determined based on the driving torques of the first agitating screw 51 and the second agitating screw 52, and consequently the degree of deterioration of the developer can be determined.

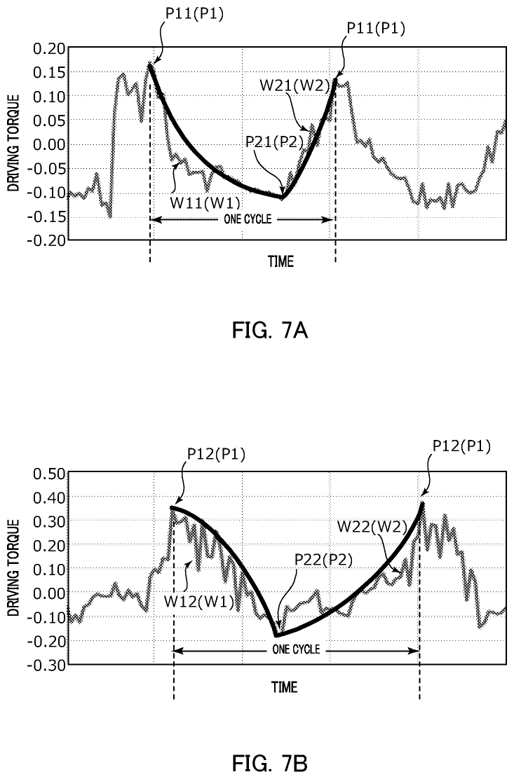

In this respect, the driving torque is smaller when the fluidity is higher than when the fluidity is lower (see FIGS. 7A and 7B). However, since the driving torque also varies depending on the amount of developer accommodated in the developer container 55, the toner concentration, and environmental factors (temperature and humidity), it is difficult to determine the fluidity based only on the driving torque.

In the present embodiment, on the other hand, it is determined, based on the waveform shape of the driving torque of the first agitating screw 51, whether the fluidity of the developer is suitable. Thus, the fluidity of the developer can be easily and appropriately determined regardless of the amount of the developer accommodated in the developer container 55, the toner concentration, and environmental factors.

Hereinafter, a case where the fluidity of the developer is determined based on the driving torque of the first agitating screw 51 will be described specifically. Note that, the fluidity of the developer may also be determined based on the driving torque of the second agitating screw 52, or may also be determined by combining the driving torque of the first agitating screw 51 with the driving torque of the second agitating screw 52.

In addition, it may also be configured such that the first agitating screw 51 and the second agitating screw 52 are driven by a single drive motor 57 and the fluidity of the developer is determined based on the driving torques of the first agitating screw 51 and the second agitating screw 52. In this case, the first agitating screw 51 and the second agitating screw 52 are driven such that peaks in the torque waveforms, where the peaks are caused by loads acting on the first agitating screw 51 and the second agitating screw 52, respectively, appear temporally at an identical timing. Thus, peaks in torque waveforms can be caused to appear more prominently.

FIG. 6 is a diagram illustrating an example of a torque waveform W when the first agitating screw 51 is rotated. As illustrated in FIG. 6, the torque waveform W when the first agitating screw 51 is rotated has periodicity regardless of the fluidity of the developer, and includes a first peak P1 and a second peak P2. The first peak P1 is a higher peak, and the second peak P2 is a lower peak.

As illustrated in FIG. 5B, the paddle 513 enters the inside of the developer from the outside of the developer in conjunction with the rotational operation of the first agitating screw 51. At this time, the developer is pushed aside by the paddle 513, and accordingly, the torque waveform W rises sharply and exhibits the first peak P1. Thereafter, as illustrated in FIG. 5C, the paddle 513 advances from the inside of the developer to the outside of the developer. At this time, the developer falls from the paddle 513, and accordingly, the torque waveform W falls and exhibits the second peak P2. That is, the one-cycle torque waveform starting from the first peak P1 has a falling waveform W1 from the starting first peak P1 toward the second peak P2, and a rising waveform W2 from the second peak P2 toward the next first peak P1 (see FIGS. 7A and 7B).

Since the first agitating screw 51 is provided with the paddle 513 that functions as the load generator, the first peak P1 and the second peak P2 appearing in the torque waveform W become more prominent than in a case where the paddle 513 is not provided.

FIGS. 7A and 7B are enlarged views of the one-cycle torque waveform in FIG. 6. The torque waveform illustrated in FIG. 7A is a torque waveform in a case where the fluidity of the developer is high. The torque waveform illustrated in FIG. 7B is a torque waveform in a case where the fluidity of the developer is low.

The matter: “the fluidity of the developer is high” means that the developer has properties suitable for forming a stable, high-quality image. In addition, the matter: “the fluidity of the developer is low” means that movement of the developer is sluggish and that the developer does not have properties suitable for image formation. This includes, for example, a case where the degree of deterioration of the developer is large and a case where the amount of charge of the developer decreases due to environmental factors (temperature and humidity) or long-term storage or the bulk density of the developer decreases due to air escaping.

As illustrated in FIG. 7A, the torque waveform in a case where the fluidity of the developer is high includes a falling waveform W11 and a rising waveform W21. As illustrated in FIG. 7B, the torque waveform in a case where the fluidity of the developer is low includes a falling waveform W12 and a rising waveform W22 in the same manner as in the case where the fluidity is high.

Comparing the falling waveforms W11 and W12, it can be said that the falling waveform W11 is steeper than the falling waveform W12. It can be said that the falling waveform W11 is convex downward, whereas the falling waveform W12 is convex upward. It can be considered that this is because, in a case where the fluidity is high, the developer scooped up by the paddle 513 is more likely to fall than in a case where the fluidity is low.

In addition, comparing the rising waveforms W21 and W22, it can be said that the rising waveform W21 is steeper than the rising waveform W22. It can be considered that this is because, in a case where the fluidity is high, the developer pushed aside by the paddle 513 returns more quickly than in a case where the fluidity is low.

As described above, since the shape of the torque waveform of the first agitating screw 51 varies depending on the fluidity of the developer, the fluidity of the developer can be determined based on the shape of the torque waveform. Then, the operation of the image forming apparatus 1 can be appropriately controlled according to the fluidity of the developer.

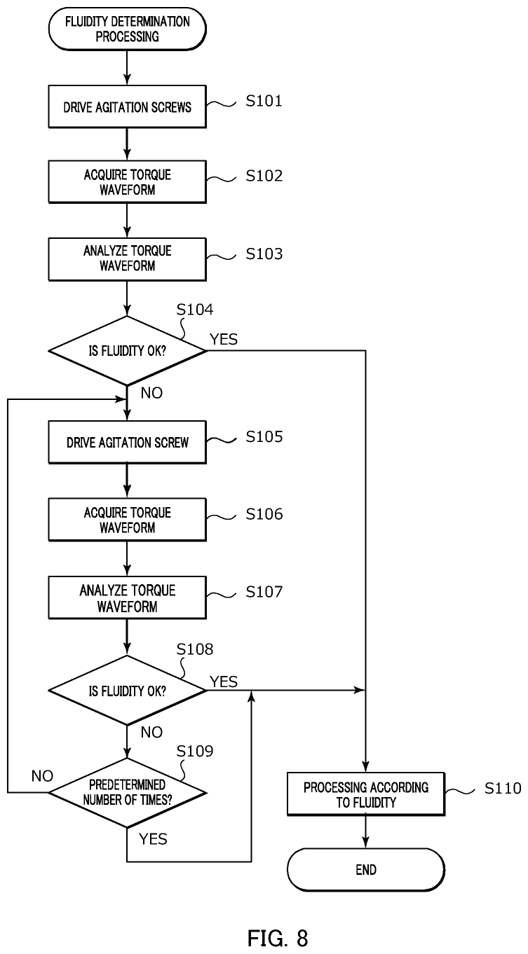

FIG. 8 is a flowchart illustrating an example of fluidity determination processing. This processing is realized, for example, by the CPU 31 executing a fluidity determination processing program accommodated in the ROM 32 at a predetermined timing, such as when the image forming apparatus 1 is started up or when a print job is received. Note that, the fluidity determination processing may also be executed in response to a user operation performed on the operation section 122.

In step S101 of FIG. 8, the control section 30 controls the drive motor 57 to drive the first agitating screw 51. At the same time, the control section 30 controls the drive motor 57 to drive the second agitating screw 52. The developer in the developer container 55 is circulated and conveyed while being agitated along with the rotation of the first agitating screw 51 and the second agitating screw 52.

In step S102, the control section 30 acquires a torque waveform indicating the driving torque of the first agitating screw 51 (processing as the torque waveform acquirer 30A). Specifically, the control section 30 acquires, as the torque waveform, a waveform of the driving current of the drive motor 57 when the feedback control is performed. Note that, the torque waveform may also be acquired based on a result obtained by directly measuring, with a torque sensor, the torque applied to the rotation shaft of the drive motor 57.

In step S103, the control section 30 analyzes the torque waveform acquired in step S102 (processing as the fluidity determiner 30B). Specifically, the control section 30 analyzes a one-cycle torque waveform to identify a first peak P1 and a second peak P2 in the torque waveform W, and calculates a determination value for determining the fluidity of the developer.

The range of the one-cycle torque waveform is set, for example, to start from the first peak P1. In this case, the torque waveform includes a falling waveform W1 from the starting first peak P1 toward a second peak P2 and a rising waveform W2 from the second peak P2 toward the next first peak P1.

In addition, the range of the one-cycle torque waveform may also be set to start from the second peak P2. In this case, the torque waveform includes a rising waveform W2 from the starting second peak P2 toward a first peak P1 and a falling waveform W1 from the first peak P1 toward the next second peak P2.

Note that, in a case where the fluidity is determined using either the falling waveform W1 or the rising waveform W2, the range of the one-cycle torque waveform may be set so as to include the falling waveform W1 or the rising waveform W2 to be used for the determination. That is, the range of the one-cycle torque waveform may not start from the first peak P1 or the second peak P2.

In step S104, the control section 30 determines, based on the determination value calculated in step S103, whether the fluidity of the developer is suitable (processing as the fluidity determiner 30B). Specifically, the control section 30 compares the determination value with a reference value to determine whether the fluidity of the developer is suitable. In a case where the fluidity of the developer is high (“YES” in step S104), the flow proceeds to the processing in step S110. In a case where the fluidity of the developer is low (“NO” in step S104), the flow proceeds to the processing in step S105.

Hereinafter, four specific examples will be described as the fluidity determination method using the determination value. Note that, the fluidity determination method is not limited to the determination methods described below as long as the determination value obtained by quantifying the shape of the torque waveform is used therein.

As a first example, the degree of curvature of a falling waveform W1 can be applied as the determination value. In this determination method, 0 is set as the reference value. The degree of curvature of the falling waveform W1 is typically represented by a coefficient a of a quadratic term when the entire waveform of the falling waveform W1 is approximated by a quadratic function y=ax2+bx+c. For example, in a case where the coefficient a is positive (a>0), the shape of the falling waveform W1 is convex downward, and thus, it can be determined that the fluidity is high (see FIG. 7A). On the other hand, in a case where the coefficient a is negative (a<0), the shape of the falling waveform W1 is convex upward, and thus, it can be determined that the fluidity is low (see FIG. 7B).

Note that, it may also be determined whether the fluidity is suitable, in consideration of not only the sign of the coefficient a but also the magnitude of the coefficient a. In addition, the degree of curvature of a rising waveform W2 may also be applied as the determination value.

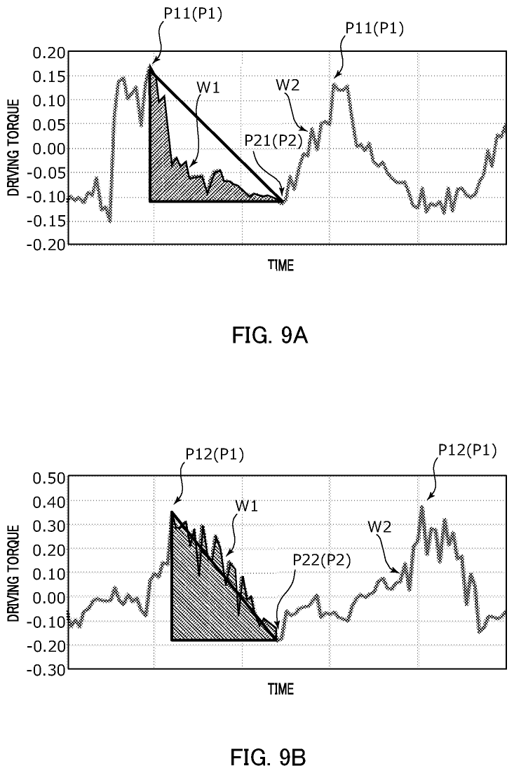

As a second example, the area of a right triangle having a hypotenuse which is a straight line connecting a first peak P1 and a second peak P2 in a falling waveform W1 can be applied as the determination value. In this determination method, the integral value of the falling waveform W1 is set as the reference value. For example, in a case where the calculated area of the right triangle is larger than the integral value of the falling waveform W1, it can be determined that the fluidity is high (see FIG. 9A). On the other hand, in a case where the calculated area of the right triangle is smaller than the integral value of the falling waveform W1, it can be determined that the fluidity is low (see FIG. 9B).

Note that, it may be determined that the fluidity is high in a case where the difference between the calculated area of the right triangle and the integral value of the falling waveform W1 is equal to or greater than a predetermined value, and it may be determined that the fluidity is low in a case where the difference is less than the predetermined value. In addition, it may also be determined whether the fluidity is suitable by comparing the area (determination value) of a right triangle having a hypotenuse which is a straight line connecting a second peak P2 and a first peak P1 in a rising waveform W2 with the integral value (the reference value) of the rising waveform W2.

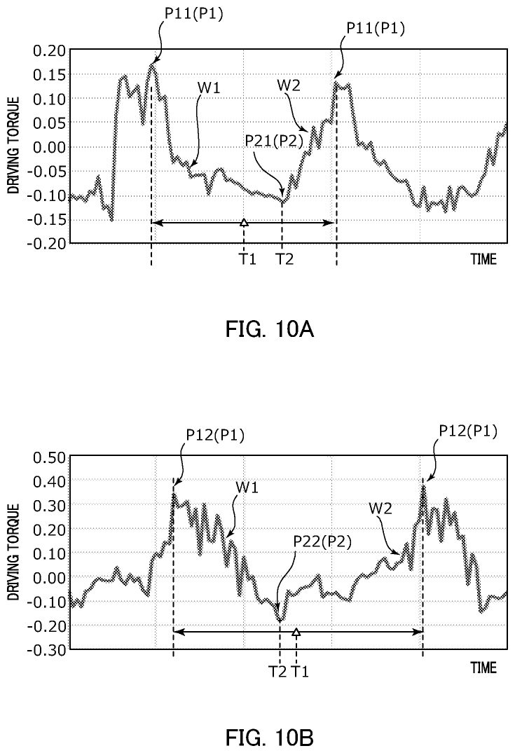

As a third example, a time-averaged position of two first peaks P1 adjacent to each other can be applied as the determination value. In this determination method, the position of a second peak P2 present between the two first peaks P1 is set as the reference value. For example, in a case where a time-averaged position T1 is temporally ahead of a position T2 of a second peak P2, it can be determined that the fluidity is high (see FIG. 10A). On the other hand, in a case where the time-averaged position T1 is temporally later than the position T2 of the second peak P2, it can be determined that the fluidity is low (see FIG. 10B).

Note that, it may also be determined whether the fluidity is suitable by comparing a time-averaged position (the determination value) of two second peaks P2 adjacent to each other with a position (the reference value) of a first peak P1 present between the two second peaks P2.

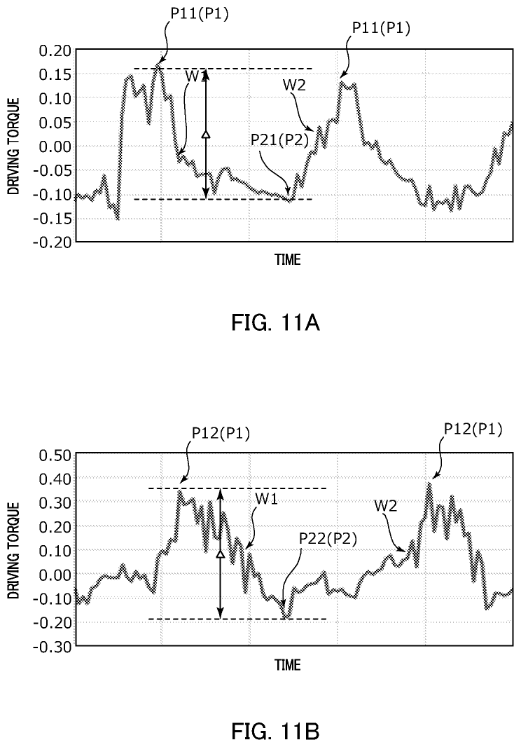

As a fourth example, the peak-to-peak intermediate value between a first peak P1 and a second peak P2 in a falling waveform W1 (hereinafter, referred to as the “inter-peak intermediate value”) can be applied as the determination value. In this determination method, the average value of all points between the peaks (hereinafter, referred to as the “inter-peak average value”) is set as the reference value. For example, in a case where the inter-peak intermediate value is greater than the inter-peak average value, it can be determined that the fluidity is high (see FIG. 11A). On the other hand, in a case where the inter-peak intermediate value is smaller than the inter-peak average value, it can be determined that the fluidity is low (see FIG. 11B).

Note that, it may also be determined whether the fluidity is suitable by comparing the inter-peak intermediate value (the determination value) between a first peak P1 and a second peak P2 in a rising waveform W2 with the inter-peak average value (the reference value).

In step S104 of FIG. 8, the fluidity of the developer is determined as described above. In a case where the fluidity of the developer is low (“NO” in step S104), the control section 30 controls the drive motor 57 to drive the first agitating screw 51 in step S105.

Note that, the processing in step S105 is processing that is executed in a case where the first agitating screw 51 is stopped after a torque waveform is acquired in step S102. In a case where the first agitating screw 51 continues to be driven without being stopped, step S105 is omitted.

In step S106, the control section 30 acquires a torque waveform anew after driving the first agitating screw 51 for a predetermined time (processing as the torque waveform acquirer 30A). The predetermined time until a torque waveform is acquired may also be adjusted according to the determination value calculated in the previous fluidity determination processing, and/or the rotational speed (the agitating speed) of the first agitating screw 51 may also be changed as appropriate.

In step S107, the control section 30 analyzes the torque waveform acquired in step S106 (processing as the fluidity determiner 30B). In step S108, the control section 30 determines, based on the determination value calculated in step S107, whether the fluidity of the developer is suitable (processing as the fluidity determiner 30B). In a case where the fluidity of the developer is high (“YES” in step S108), the flow proceeds to the processing in step S110. In a case where the fluidity of the developer is low (“NO” in step S108), the flow proceeds to the processing in step S109. Since the processing in steps S106 to S108 are the same as the processing in steps S102 to S104, detailed descriptions thereof will be omitted.

In step S109, the control section 30 determines whether the fluidity determination processing (steps S102 to S104 and S106 to S108) has been performed a predetermined number of times. In a case where the determination processing has been performed the predetermined number of times (“YES” in step S109), it means that the fluidity of the developer will not be restored by agitating In this case, the flow proceeds to the processing in step S110. In a case where the determination processing has not been performed the predetermined number of times (“NO” in step S109), the fluidity of the developer may be restored by agitating. In this case, the flow returns to the processing in step S105.

In step S109, the predetermined number of times may be twice or more and is set to three times, for example. By performing the fluidity determination processing a plurality of times, the accuracy in the fluidity determination improves. Note that, the determination result (the determination value and whether the fluidity is suitable) may be temporarily stored, and, in a case where similar determination results are obtained consecutively, it may be finalized whether the fluidity is suitable.

In a case where it is determined in step S109 that the determination processing has been performed the predetermined number of times, it means that the fluidity of the developer will not be restored even when the agitation is performed, that is, the degree of deterioration of the developer is large. In this case, the control section 30 executes, in step S110, processing that can be performed in a case where the fluidity is low (processing as the operation controller 30C).

For example, the control section 30 controls the display section 121 to notify the user that the developer needs to be replaced. In addition, for example, the control section 30 may cause a deteriorated developer to be discharged forcibly from the developer container 55 and may cause processing of supplying toner and a carrier to be performed until the fluidity of the developer is restored.

In a case where it is determined in step S104 or step S108 that the fluidity of the developer is high, the developer is in a state suitable for printing. In this case, the control section 30 executes, in step S110, processing that can be performed in a case where the fluidity is high (processing as the operation controller 30C).

Specifically, in the case of fluidity determination processing executed when the image forming apparatus 1 is started up, the control section 30 causes the driving of the first agitating screw 51 to be stopped and causes the first agitating screw 51 to stand by until a print job is received, for example. Since the developer is maintained in a state of having appropriate fluidity, the quality of an image printed based on a print job received thereafter is stabilized. Note that, in a case where a predetermined time has elapsed between the execution of the fluidity determination processing and the execution of a print job, the fluidity of the developer may have decreased, and thus, the fluidity determination processing may be executed anew.

In addition, for example, the control section 30 causes processing of detecting the amount of developer by utilizing a liquid level sensor (illustration is omitted) to start. That is, in the fluidity determination processing, the processing of detecting the liquid level of the developer may be executed in response to a determination that the fluidity of the developer is high. In a case where the fluidity is high, the liquid level of the developer is stable, and thus, it is possible to prevent erroneous detection of the liquid level and consequently it is possible to perform appropriate control according to the liquid level.

In addition, in the case of fluidity determination processing executed when a print job is received, the control section 30 causes the execution of the print job to start. That is, in the fluidity determination processing, print processing based on a print job may be executed in response to a determination that the fluidity of the developer is high. Since the developer is in a state of having appropriate fluidity, the quality of an image printed based on a print job is stabilized.

Note that, the processing according to the fluidity of the developer in step S110 is not limited to the processing described above. For example, in a case where it is determined that the fluidity of the developer is high and printing can be performed, but further recovery of the fluidity is expected, the first agitating screw 51 may be driven at a rotational speed increased according to a determination value indicating the fluidity, and the driving may be stopped or the processing of detecting the liquid level may be started after the fluidity is stabilized.

As described above, the image forming apparatus 1 according to the embodiment includes the following features singly or in appropriate combination.

That is, the image forming apparatus 1 includes: the developing apparatus 212 that accommodates a developer; the first agitating screw 51 (agitating member) that agitates the developer by a rotational operation; the torque waveform acquirer 30A that acquires a torque waveform W indicating the driving torque of the first agitating screw 51; and the fluidity determiner 30B that analyzes the torque waveform W acquired by the torque waveform acquirer 30A and determines, based on the shape of the torque waveform W, whether the fluidity of the developer is suitable.

The fluidity determination method of determining the fluidity of a developer in the image forming apparatus 1 includes: agitating a developer accommodated in the developing apparatus 212 by a rotational operation of the first agitating screw 51 (agitating member); acquiring a torque waveform W indicating the driving torque of the first agitating screw 51; analyzing the acquired torque waveform W; and determining, based on the shape of the torque waveform W, whether the fluidity of the developer is suitable.

According to the image forming apparatus 1 and the fluidity determination method according to the embodiment, the fluidity of the developer can be easily and appropriately determined regardless of the amount of the developer accommodated in the developing apparatus 212, the toner concentration, and environmental factors.

In the image forming apparatus 1, the first agitating screw 51 (agitating member) includes a paddle 513 (load generator) that cyclically moves between the inside of the developer and the outside of the developer in conjunction with the rotational operation. Thus, a prominent peak can be caused to appear in a torque waveform of the first agitating screw 51 and the accuracy in the fluidity determination improves.

The image forming apparatus 1 includes the first agitating screw 51 and the second agitating screw 52 (a plurality of agitating members), and the first agitating screw 51 and the second agitating screw 52 are driven such that peaks in torque waveforms appear temporally at an identical timing, where the peaks are caused by loads acting on the first agitating screw 51 and the second agitating screw 52, respectively. Thus, a more prominent peak can be caused to appear in a torque waveform for determining the fluidity and the accuracy in the fluidity determination improves.

In the image forming apparatus 1, the fluidity determiner 30B detects, in one cycle of the torque waveform W, peaks including a first peak P1, which is a higher peak, and a second peak P2, which is a lower peak, and determines, by using at least one of a falling waveform W1 from the first peak P1 toward the second peak P2 and/or a rising waveform W2 from the second peak P2 toward the first peak P1, whether the fluidity is suitable. Thus, the fluidity can be easily determined based on the shape of the torque waveform W.

In the image forming apparatus 1, the fluidity determiner 30B determines, based on the degree of curvature of an entire waveform of the falling waveform W1 and/or the rising waveform W2, whether fluidity is suitable. Thus, the fluidity can be easily determined by quantifying the shape of the torque waveform.

In the image forming apparatus 1, the fluidity determiner 30B determines, based on the area of a right triangle having a hypotenuse which is a straight line connecting the first peak P1 and the second peak P2, whether fluidity is suitable. Thus, the fluidity can be easily determined by quantifying the shape of the torque waveform.

In the image forming apparatus 1, the fluidity determiner 30B uses a falling waveform W1 and a rising waveform W2 to determine, based on the time-averaged position of two first peaks P1 adjacent to each other and/or the time-averaged position of two second peaks P2 adjacent to each other, whether the fluidity is suitable. Thus, the fluidity can be easily determined by quantifying the shape of the torque waveform.

In the image forming apparatus 1, the fluidity determiner 30B determines, based on the inter-peak intermediate value between the first peak P1 and the second peak P2, whether the fluidity is suitable. Thus, the fluidity can be easily determined by quantifying a torque waveform.

The image forming apparatus 1 further includes the operation controller 30C that causes a predetermined operation to be performed according to a determination result by the fluidity determiner 30B. Thus, it is possible to cause the image forming apparatus 1 to perform an appropriate operation according to the determination result of the fluidity.

Although the invention made by the present inventors has been specifically described above based on the embodiment, the present disclosure is not limited to the above-described embodiment and can be modified without departing from the spirit thereof.

In the embodiment, the fluidity of the developer is determined based on a torque waveform(s) of the first agitating screw 51 and/or the second agitating screw 52. However, an agitating member may also be provided in addition to the agitating screws 51 and 52, and the fluidity of the developer may also be determined using a torque waveform of the agitating member.

In addition, for example, the paddles 513 and 523 provided to project from the screw shafts 511 and 521 function as the load generator, but recessed portions may be provided in the screw shafts 511 and 521 to function as the load generator.

Although embodiments of the present invention have been described and illustrated in detail, the disclosed embodiments are made for purpose of illustration and example only and not limitation. The scope of the present invention should be interpreted by terms of the appended claims.

What is claimed is:

1. An image forming apparatus, comprising:
a developing apparatus that accommodates a developer;
an agitating member that agitates the developer by a rotational operation;
a torque waveform acquirer that acquires a torque waveform indicating a driving torque of the agitating member; and
a fluidity determiner that analyzes the torque waveform acquired by the torque waveform acquirer and determines, based on a shape of the torque waveform, whether fluidity of the developer is suitable.

2. The image forming apparatus according to claim 1, wherein
the agitating member includes a load generator that cyclically moves between an inside of the developer and an outside of the developer in conjunction with the rotational operation.

3. The image forming apparatus according to claim 1, comprising a plurality of the agitating members, wherein
the plurality of agitating members is driven such that a plurality of peaks in a plurality of the torque waveforms appears temporally at an identical timing, the plurality of peaks being caused by a plurality of loads acting on the plurality of agitating members, respectively.

4. The image forming apparatus according to claim 1, wherein
the fluidity determiner detects, in one cycle of the torque waveform, a plurality of peaks including a first peak and a second peak and determines, by using at least one of a falling waveform and/or a rinsing waveform, whether the fluidity is suitable, the first peak being a higher peak, the second peak being a lower peak, the falling waveform being a waveform from the first peak toward the second peak, the rising waveform being a waveform from the second peak toward the first peak.

5. The image forming apparatus according to claim 4, wherein
the fluidity determiner determines, based on a degree of curvature of an entire waveform of the falling waveform and/or the rising waveform, whether the fluidity is suitable.

6. The image forming apparatus according to claim 4, wherein
the fluidity determiner determines, based on an area of a right triangle having a hypotenuse, whether the fluidity is suitable, the hypotenuse being a straight line connecting the first peak and the second peak.

7. The image forming apparatus according to claim 4, wherein
the fluidity determiner determines, based on a time-averaged position of, among a plurality of the first peaks, two first peaks adjacent to each other and/or a time-averaged position of, among a plurality of the second peaks, two second peaks adjacent to each other, whether the fluidity is suitable.

8. The image forming apparatus according to claim 4, wherein
the fluidity determiner determines, based on an intermediate value between the first peak and the second peak, whether the fluidity is suitable.

9. The image forming apparatus according to claim 1, further comprising an operation controller that causes a predetermined operation to be performed according to a determination result by the fluidity determiner.

10. A fluidity determination method, comprising:
agitating a developer accommodated in a developing apparatus by a rotational operation of an agitating member;
acquiring a torque waveform indicating a driving torque of the agitating member;
analyzing the acquired torque waveform; and
determining, based on a shape of the torque waveform, whether fluidity of the developer is suitable.
